(19) United States
(12) Patent Application Publication
(10) Pub. No.: US 2003/0029891 A1
(43) Pub. Date: Feb. 13, 2003

(54) Resealable cap for carbonated beverage can

(76) Inventor: Tony M. Alexander, Six Mile, SC (US)

Correspondence Address: J. Herbert O'Toole, Nexsen Pruet Jacobs & Pollard, LLC, P.O. Box 10107, Greenville, SC, 29603, US

(21) Appl. No.: 10/071,616

(22) Filed: Feb. 8, 2002

Related U.S. Application Data
(63) Continuation-in-part of application No. 09/927,157, filed on Aug. 10, 2001, now Pat. No. 6,478,179.

(51) Int. Cl. B67D 3/00

(52) U.S. Cl. 222/536; 222/570

(57) ABSTRACT

A device for sealing an open beverage can employs a cap and clamping jaws articulated from the cap which lock into the top lid of the can to push the can into secure contact with the cap. The cap may include a turret and straw for drinking from the can without removing the cap. Insulating sleeves to keep the beverage cold may be part of the cap.

This application is a continuation-in-part of copending U.S. patent application Ser. No. 09/927,157 filed Aug. 10, 2001.

### BACKGROUND OF THE INVENTION

1. Field of the Invention

The invention is directed to devices for resealing containers of carbonated beverages and, optionally, retarding their warming.

2. Background in Prior Art

Carbonated beverages are extremely popular worldwide and the containers in which they are provided have become standardized. A typical can holds 355 ml (12 fl.oz.), has as a top with a diameter of approximately 550 mm and includes a depressed area having a frangible region adjacent a “pop top” lever which opens the can by pushing the frangible section into the can. Opening releases some of the carbon dioxide dissolved in the beverage and allows the liquid to be poured into a container or, alternatively, the beverage may be drunk directly from the container or through a straw.

A persistent problem when the cans contain soda pop and the consumers are pre-adolescent children is that, before the contents are consumed, the can is either spilled or the carbonation is lost. When the product is spilled it cannot be drunk and when the product loses carbonation, typically with attendant warming, it will not be drunk. As a result, there is a need for a simple, convenient, and inexpensive device which allows a conventional can of carbonated beverage to be resealed for further use, which is spill-proof but still allows the product to be accessible and which is economically effective.

Numerous attempts have been made to address this problem. U.S. Pat. No. 4,429,804 to Pease discloses a beverage can resealer which uses a cam-actuated foot inserted through the pouring hole to hold a covering body over the top. U.S. Pat. No. 4,804,103 to Goldberg employs a cam-locked lever also utilizing a component which presses against the undersurface of the can lid. Both of the above-mentioned references require that the sealing apparatus be removed before beverage can be removed from the container.

U.S. Pat. No. 5,065,909 to Pino et al. discloses a snap-on cap to be pressed over the top of a beverage can and includes a straw and a tubular lever with a valve at its base which allows someone to draw liquid through the straw when the lever is in the open position. U.S. Pat. No. 5,105,964 to Heath discloses a snap-on cap for a beverage can which serves to reseal the container but which must be removed before the contents may be poured. U.S. Pat. No. 5,110,002 to Tucker discloses a snap-on cap fitted with a separate cover which may be located over the opening in the top of the can and includes a screen to keep out flying insects, especially bees. U.S. Pat. No. 5,203,467 to Tucker discloses a variant of the above having a different snapping arrangement to retain the cover.

U.S. Pat. No. 5,242,079 to Stephens et al. discloses a spout and straw similar to U.S. Pat. No. 5,065,909 to Pino et al. improved by the presence of a vent which is opened with the rotating spout to prevent spurting of the beverage due to pressure increases in the can on warming. U.S. Pat. No. 5,402,904 to Close discloses a variant of the Tucker patents which snaps onto the top surface of the can.

U.S. Pat. No. 5,452,818 to Youst discloses a one-piece snap-on cover without vent holes, similar to the Heath '964 patent. U.S. Pat. No. 5,467,888 to Brandstrom et al. discloses a conical cover and spout similar in appearance to a inverted funnel which is held in place using a separate annular ring. U.S. Pat. No. 5,873,478 to Sullivan et al. discloses a sealing cap, preferably for a bottle having screw threads and including a levered spout and a valving system to prevent squirting of the carbonated beverage when the spout is opened. U.S. Pat. No. 6,039,207 to Adamek discloses an insulating cylinder into which a beverage can is inserted and a hinged cap which seals the container. U.S. Pat. No. 6,053,347 to Fullin discloses a cover seal for a can of carbonated beverages which includes four fingers which engage the outside of the top of the beverage can and which are pulled into place using a cam and lever system. The cover must be removed before the contents can be poured or drunk. U.S. Pat. No. 6,073,797 to Barous discloses a snap-on cover for a can having a sliding top which opens and closes the orifice. U.S. Pat. No. 6,116,458 to Dark discloses a flexible straw ending in a pivoted drinking spout primarily designed to attach to a cup. U.S. Pat. No. 6,155,452 to Lurent discloses a seal for a beverage can which includes a cup or insulating sleeve directly engageable to the can.

The number of attempts to affix a cap to an open beverage can which allows access without removing the cap and while providing secure affixation attest to the difficulty of the task at hand.

### BRIEF SUMMARY OF THE INVENTION

It is an object of the invention to provide a sealing cap for a beverage can which locks securely in place to maintain carbonation of the contents. It is further object of this invention to provide a cover which allows access to the contents through a straw and a flip-up spout. It is a further object of this invention to provide a seal and drinking spout for a beverage can. It is a still further object to provide a sealing cap which incorporates means for insulating the container from the heat.

These and other objectives may be achieved by providing a sealing cap having at least one clamping member articulated from the cover which may be locked in place by engaging the outer rim of the lid of the beverage can. Mechanical locking systems useful in accordance with this invention include cam and lever arrangements, eccentric ramps and screw chucks, slip nuts, and latches.

### BRIEF DESCRIPTION OF THE DRAWINGS

FIG. 1 illustrates a first embodiment of the invention which employs a hinge pin in a sealing cap and external lever.

FIG. 2 illustrates a second embodiment of the invention using a suspensory link to locate a lever and clamping jaw.

FIGS. 3A, 3B and 3C illustrate a straw attached to a sealing cap through a vent port.

FIG. 4 illustrates a seal using a cam actuation from the top.

FIG. 5 illustrates an embodiment of the invention wherein the lock is affected by twisting a slip nut.

FIG. 6 is a detail of the locking clamp of FIG. 5.

FIGS. 7A and 7B are embodiments of the invention using a cam lever and a floating hinge.

FIGS. 8A, 8B and 8C illustrate embodiments of the invention employing a cap and slip nut.

FIGS. 9A, 9B and 9C illustrate embodiments of the invention using a pull rod.

FIGS. 10A and 10B illustrate embodiments incorporating a straw and a insulating sleeve; and

FIGS. 11A and 11B are alternative embodiments having an insulated sleeve.

FIGS. 12A and 12B are third embodiments of the invention having an insulating sleeve integral with a locking lever and optionally including a bottom cap.

FIG. 13 is a fourth embodiment having an insulating sleeve and a sealing cap held together by a slip nut.

FIGS. 14A and 14B illustrate embodiments wherein the external lever forces a fork vertically upwards into the lip of a can.

FIG. 15 illustrates a first embodiment using a geared lever with an insulated sleeve.

FIG. 16 illustrates a second embodiment using a gear mechanism to hold a cap on an insulated sleeve.

FIG. 17 illustrates the use of a rack and a pawl to hold a sealing cap onto a insulated sleeve.

FIGS. 18A and 18B illustrate linked latch levers to provide increased mechanical advantage when drawing a cap onto an insulated sleeve.

FIGS. 19A, 19B and 19C illustrate the use of a slip nut and detent pin to lock a cap in place on a insulated sleeve.

FIGS. 20A, 20B and 20C illustrate an alternative locking mechanism for holding a can in a sleeve against a cap.

FIG. 21 illustrates a screw-on cap and hard insulated cup to seal a can when not in use.

FIG. 22 illustrates the use of a guide to orient a sealing cap and can when attaching.

### DETAILED DESCRIPTION OF THE INVENTION

The sealing cap of this invention employs clamping jaws which grasp tightly a beverage can at the end (top) which carries the frangible opening, typically a “pull-tab” opening. Beverage cans, especially those designed to contain 355 ml, are formed from two pieces of aluminum. The can is formed as a closed cylinder from a single stamping and a cover plate including the opening device is attached as a type of end plate or cap. To effect a good seal, the covering plate is crimped around the end of the first cylindrical portion. The circumferential region at the crimp area becomes the strongest part of the container because it is three layers in effective thickness. In most configurations currently in use there exists a small lip where the covering plate ends.

This invention takes advantage of the lip and the inherent strength of the can at that region to effect a good seal by drawing down a sealing cap using jaws to engage the can at the lip. The sealing cap is substantially circular and may bear a gasket around the edge which engages with the lip of the beverage container. The clamping jaws are forced radially inwardly at one or more locations and locked in place by a variety of means to be discussed below. The jaws are articulated so as to lift as they move inwardly so as to draw the can into the sealing cap.

The invention may also be used with PET plastic bottles with similarly sized mouths, such as are used for some “sport drinks.”

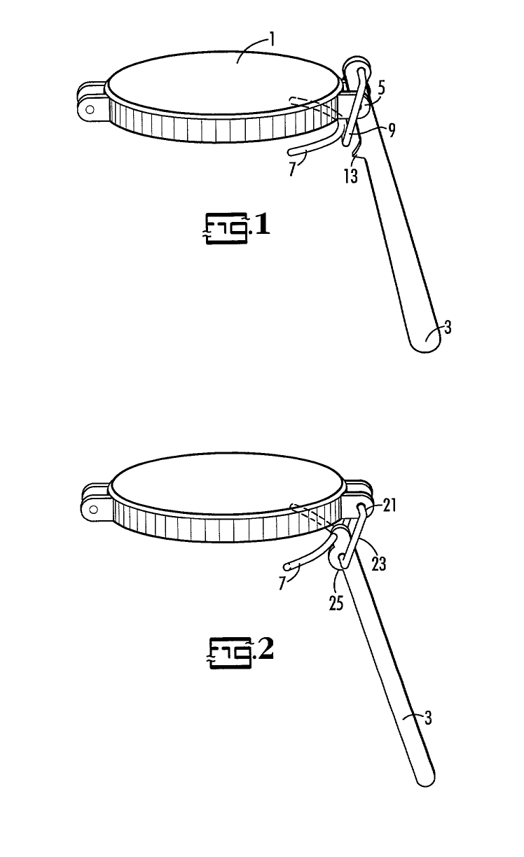

As shown in FIG. 1 a sealing cap 1 carries at least one lever 3 attached through hingepin 5 and articulated to thrust clamping jaw 7 radially inward toward the can. In the embodiment shown in FIG. 1, the clamping jaw is actuated by a combination of secondary lever 9 hinged to lever 3 and secured in place by an engaging foot 13 protruding from lever 3.

FIG. 2 illustrates an alternative embodiment wherein the lever 3 carries clamping jaw 7 as an extension of the lever and the combination is held in place by a suspensory lever 23 hinged to the sealing cap 1 by hingepin 21 and to the lever by an articulation effecting a hinge at 25. In FIGS. 1 and 2, only one combination lever and securing jaw have been illustrated. The invention may entail multiple combinations of levers to secure the device in place.

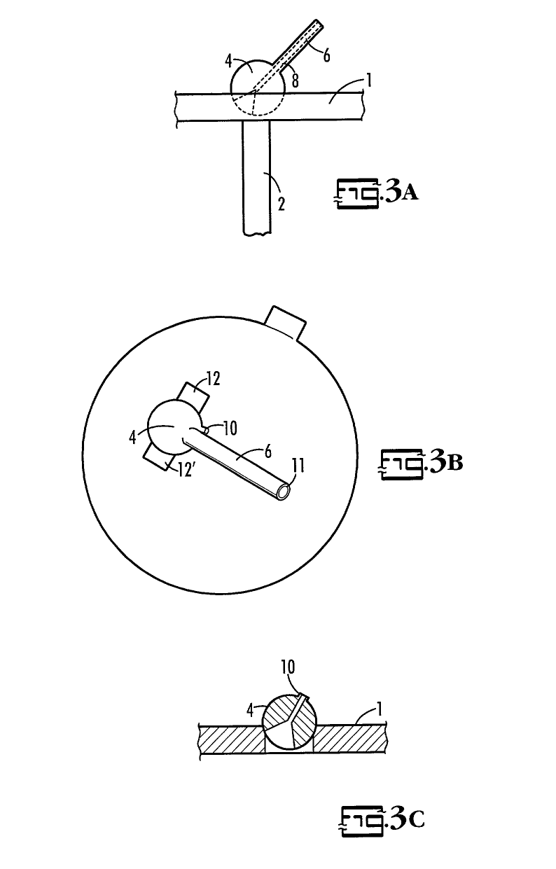

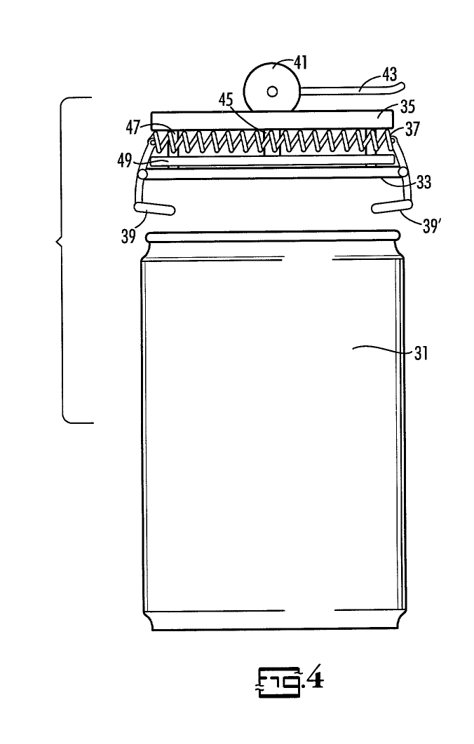

The device illustrated in FIGS. 1 and 2 may serve merely as a cap to maintain carbonation pressure and prevent spills. In a preferred embodiment the sealing cap would incorporate a straw descending into the beverage container and a flip-up tubular spout to which liquid may be drawn. FIG. 3A is a side elevation of a suitable straw arrangement. Straw 2 extends below cap 1. The straw may be integral with cap 1 or attach by insertion into a bore hole (not shown) or slid around a small tubular extension (not shown). A turret 4 having a projection 6 is hingeably rotated in or above cap 1. As shown in FIG. 3B. the turret may be mounted on cap 1 using attaching points 12, 12′. The attaching points provide hinging points to allow the turret to be snap-fitted onto the cap using hinge pin extensions from the turret, nibs on the turret or stub hinges or by other means which allow disassembly for cleaning. A bore 8 passes through projection 6 into the turret and provides communication to straw 2 when rotated. When connection is established, projection 6 becomes a straw and the liquid in the beverage container may be drawn out through opening 11. A second opening 10 which may connect to bore 8 but preferably is vented under cap 1 as shown in FIG. 3C serves to provide a pressure release when projection 6 is first raised and also allows make-up air to enter the container. Second opening 10 preferably opens before the straw bore 8 is opened;

When the flip-up straw as described above is used, the cap may be left in place and the contents withdrawn over a period of time without fear of spillage or loss of carbonation. The device is particularly useful when it is preferred to put the beverage can back into a refrigerator or cooler.

FIG. 4 illustrates an alternative embodiment for actuation of the clamping jaws. As illustrated in FIG. 4, atop a beverage can 31 is placed a device which consists of a sealing cap 33 which engages the lip of the can 31. At least 2 clamping jaws 39, 39′ are pivoted on the sealing cap for engagement with the lip of the can. A cover plate 35 may be supported a distance from sealing cap 33 by stilts 47. A cam-lock 41 having a lever 43 is connected to a pull rod 45 which draws up a disk plate 49 which engages the upper end of clamping jaws 39, 39′ and causes the lower end to project inwardly and upwardly grasping the can. When the cam-lock is released a spring 47 acts to urge the clamping jaws 39, 39′ outwardly. This embodiment is preferredly a sealing arrangement and is not suitable for use with a flip-up straw.

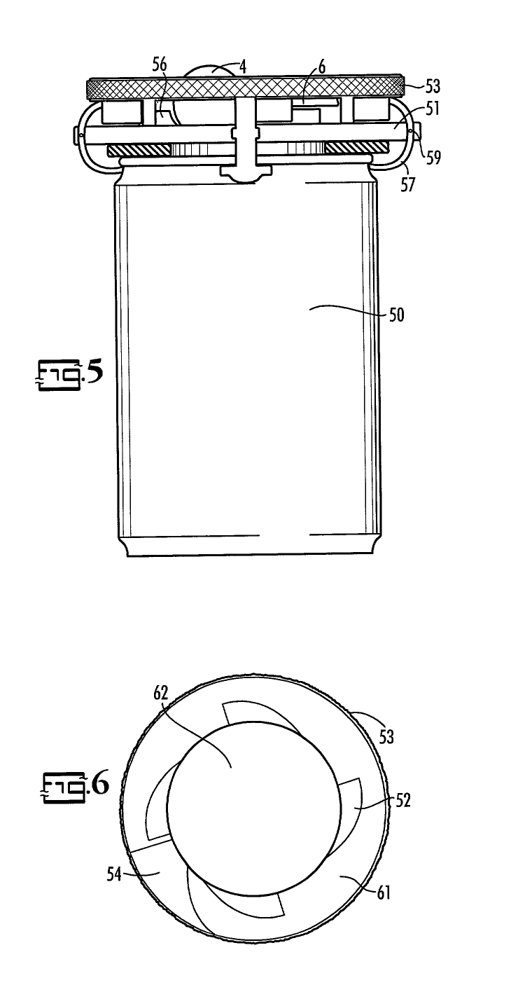

FIGS. 5 and 6 illustrate another embodiment employs a slip nut to clamp to the beverage can. A seal cap 51 is placed on a beverage can 50. The seal cap 51 carries clamping jaws 57 which are articulated at hinges 59 and an upper portion thereof and engages locking slip nut 53. As seen from FIG. 6 the knob has expanding ramps 52 which would be integral with the knob 53 and which form an arch so that upon engagement of the top end of jaw 57 the top is rotated radially outward from the center line of the seal cap and the jaws are moved radially inward and upwardly to engage the top of can 50. A step 61 at the end of the ramp provides a space whereby the clasping jaws may be held in the early disengaged position. The center 62 of the slip nut 53 is open to allow passage of the straw.

As shown in FIG. 5, a valve mechanism 4 and a flip-up straw 6 may be used with this configuration and may incorporate a straw extending from the seal cap as shown in FIG. 3a into the beverage can. It is preferred that the outer surface of seal cap 51 and clamp knob 53 have a serrated or knurled edge. At least one retainer 56 projecting upwardly from seal cap 51 cages the slip nut 53 to prevent separation. A second ramp and stop landing 54 optionally may be used to push the jaws out when releasing the can and to prevent the jaws being released by over tightening.

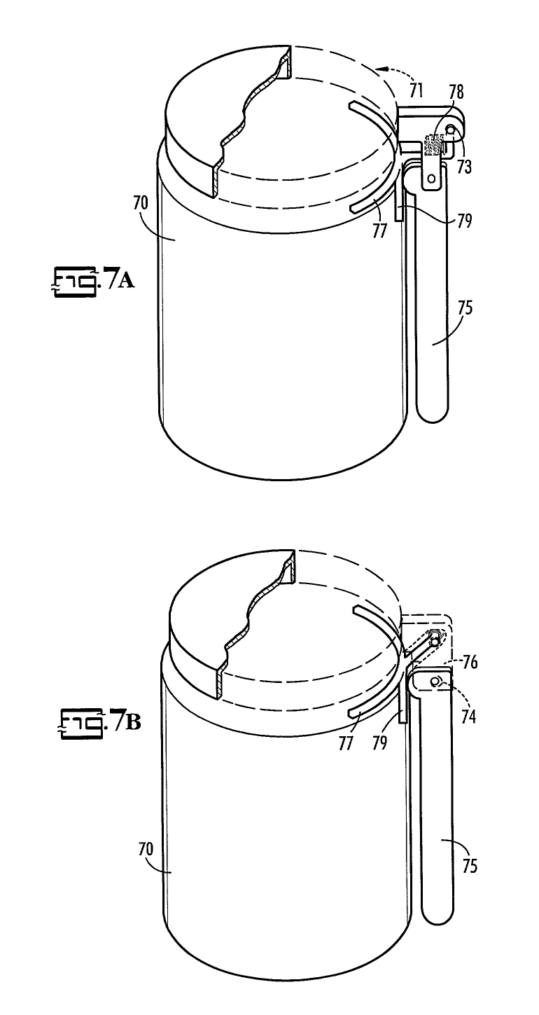

FIG. 7A illustrates an alternative embodiment when the sealing cap 71 is placed on beverage can 70. Lever 75 acting through hinge 73 forces clamping jaw 77 into engagement with the beverage can and to pull the can into contact with the seal. In this embodiment this clamping jaw is floated from a hinge in the sealing cap and pressure is applied to an actuating arm 79. A spring 78 may be used to maintain proper tension.

A variation of the arrangement shown in FIG. 7A is that shown in FIG. 7B. In this embodiment, the hinge 74 connects cap 71 and lever 75 using ears 76 to create a fulcrum point and the jaw 77 is articulated using a channel instead of hinge 73. As shown, this embodiment may use one lever 75, the circumference of the sealing cap providing a surface against which the can is forced. Multiple levers may also be used. A turret and straw such as shown in FIG. 3A and FIG. 3B may be a part of seal cap 71.

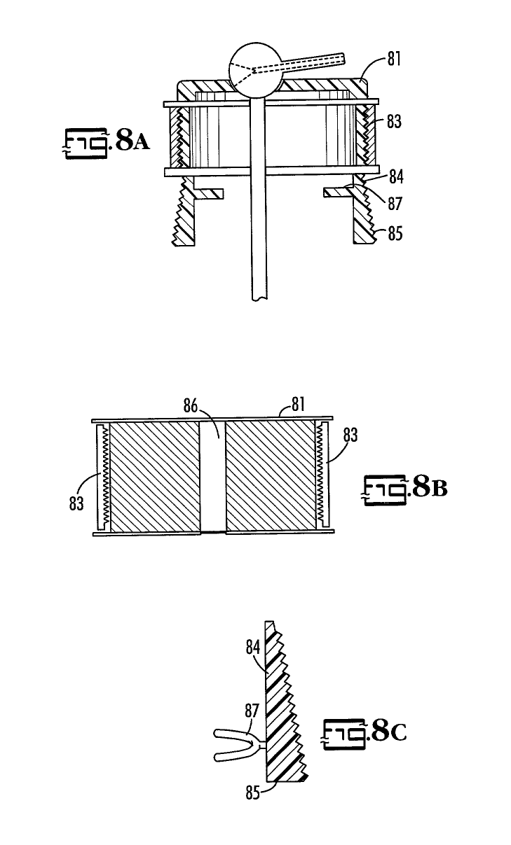

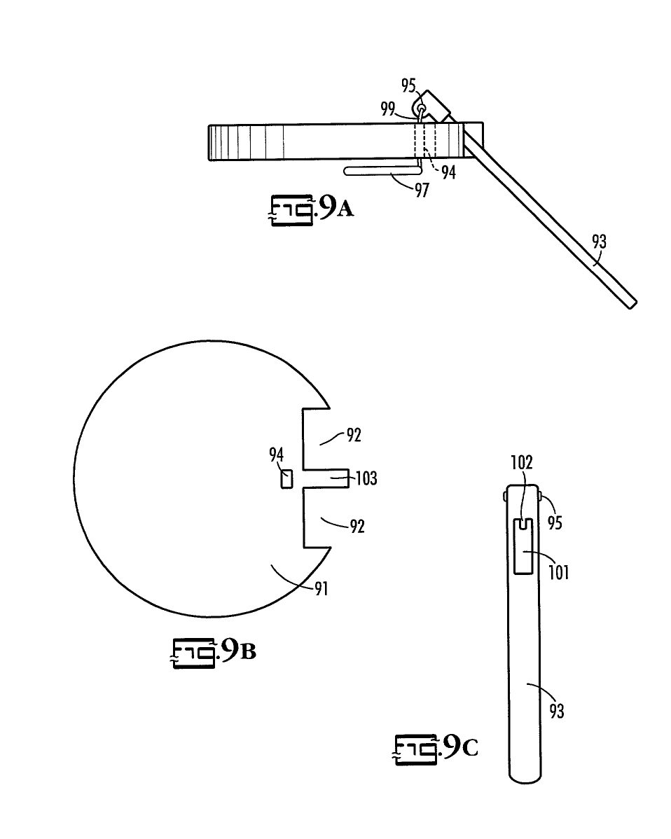

FIGS. 8A, 8B and 8C illustrate additional embodiments wherein threaded sleeve or slip nut 83 may be twisted about sealing cap 81 but behind the sleeve. As the sleeve is screwed down projecting arms 85 having fretted sides 84 are compressed inwardly to engage the locking jaws 87 into the sides of the beverage can. A smaller version of this embodiment may be used with a plastic bottle. In an alternative embodiment shown in FIGS. 8B and 8C, a slot 86 may be formed in sealing cap 81 and the arms 85 and locking jaws 87 may slide vertically upward in slot 86 as the slip nut 83 is turned. The slip nut does not move relative to the sealing cap.

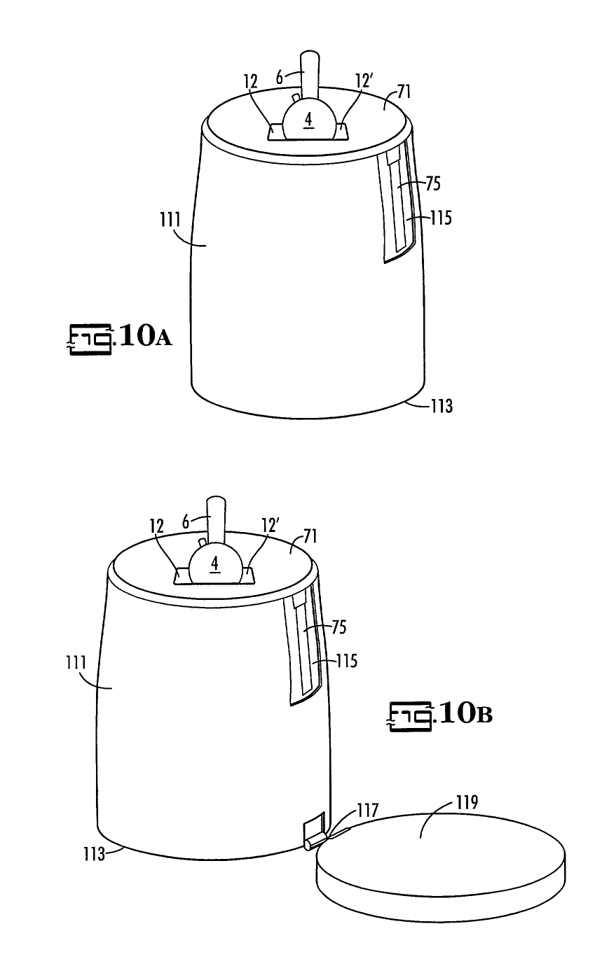

FIGS. 9A, 9B and 9C show another embodiment in which the lever 93 engages in slots 92 in sealing cap 91 and the clamping jaws 97 are actuated by a hinge 95 and link lever 99 which pass through a hole in the sealing cap 94. FIG. 9A illustrates and alternative embodiment. As shown especially in FIG. 9C, a locking step 101 on the side of lever 93 (the side facing the beverage can) having a beveled notch 102 engages the projection 103 from sealing cap 91 to provide a locking action on clamping jaws 97 to hold the sealing cap in position. A turret such as shown in FIG. 3A and FIG. 3B may be attached to sealing cap 91. Preferably, a ramp 96 extends from locking jaws 97 to exert greater pressure.

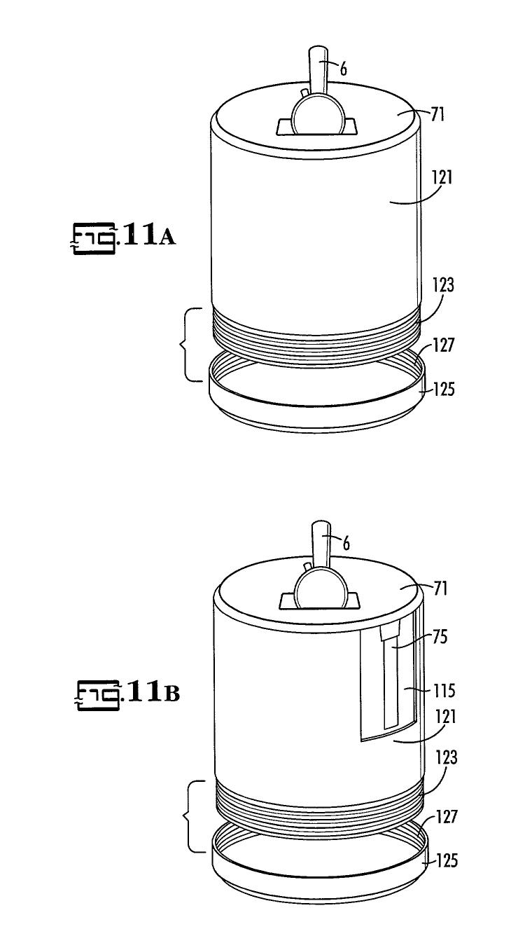

FIG. 10A illustrates the use of the cap of this invention together with an insulating sleeve. Sealing cap 71, together with locking lever 75 are secured to an insulating sleeve 111, leaving opening 113 for insertion of a beverage can. A voided area 115 in sleeve 111 allows closure of lever 75 to effect locking of the beverage can to sealing cap 71 which is then fittingly secured within the sleeve.

FIG. 10B shows an alternative to the sleeve design of FIG. 10A. A bottom cover 119 attached to sleeve 111 at hinge 117 may be snapped in place after the can is locked into place.

FIG. 11 shows an alternative which is a second embodiment of a sealing cap with insulating sleeve. In this embodiment, sealing cap 71 is formed integrally with a rigid insulating sleeve 121. At the bottom of insulating sleeve 121 or has external threads 123. A cap 125 having internal threads 127 is engaged with the insulating sleeve 121 to lock the beverage container into engagement with sealing cap 71. A straw arrangement 6 as shown in FIGS. 3A and 3B may be incorporated. Optionally, a handle may be formed with or attached to the insulating sleeve 121.

The features of FIGS. 10A and 11A may be combined as shown in FIG. 11B to accommodate different or non-standard cans.

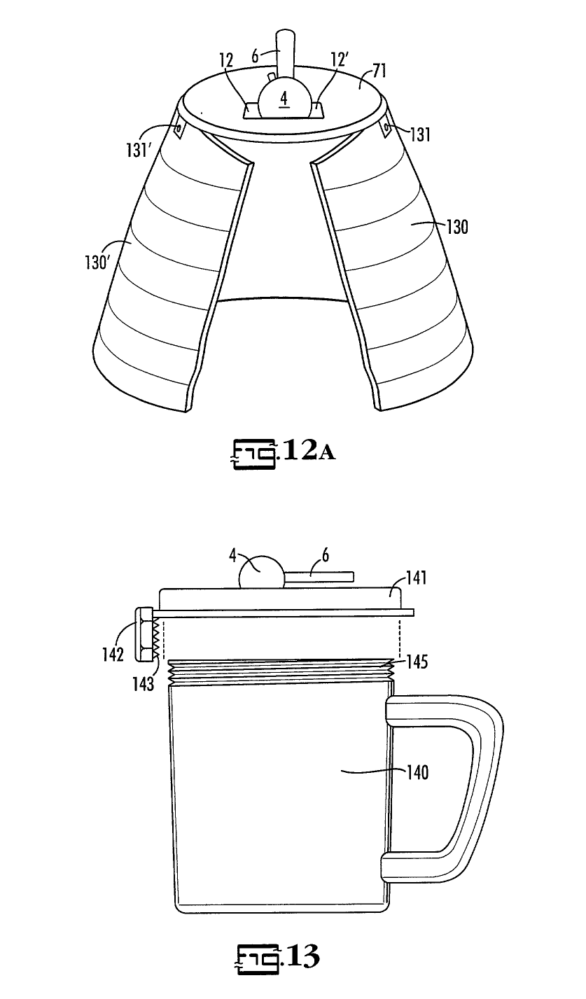

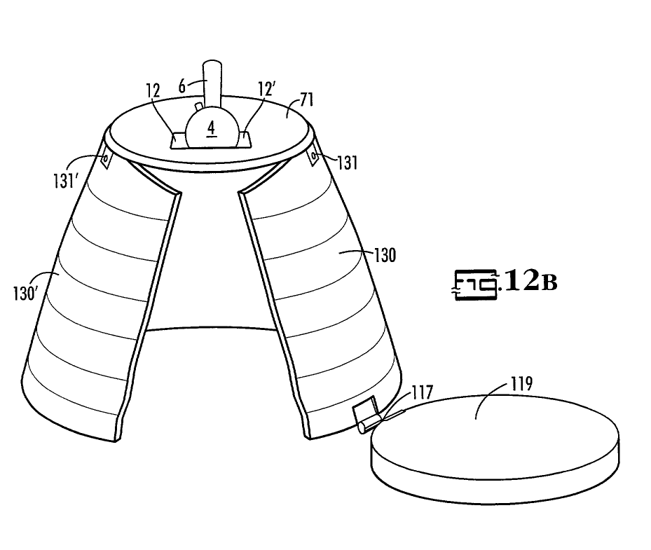

FIG. 12 illustrates a combination of sealing cap and insulating sleeve in which the lever and insulator are combined. The clamshell has a sealing cap 71, turret 4, straw 6, hinges 12, 12′. Levers as illustrated in any one of FIGS. 1,2,7A,7B,9A,9B and 9C, are integrated with an insulating half shell 130, 130′ hinged to cap 71 at 131, 131′. A cap 119 and hinge 117 similar to that used in FIG. 10B may be used, as shown in FIG. 12B.

FIG. 13 illustrates another embodiment of the invention. An insulated cup 140 accepts a beverage can and sealing cap 141 with turret 4, and straw 6 is pressed onto the cup by means of a slip nut 142 having threads 143 which engage threads 145 on the cup 140.

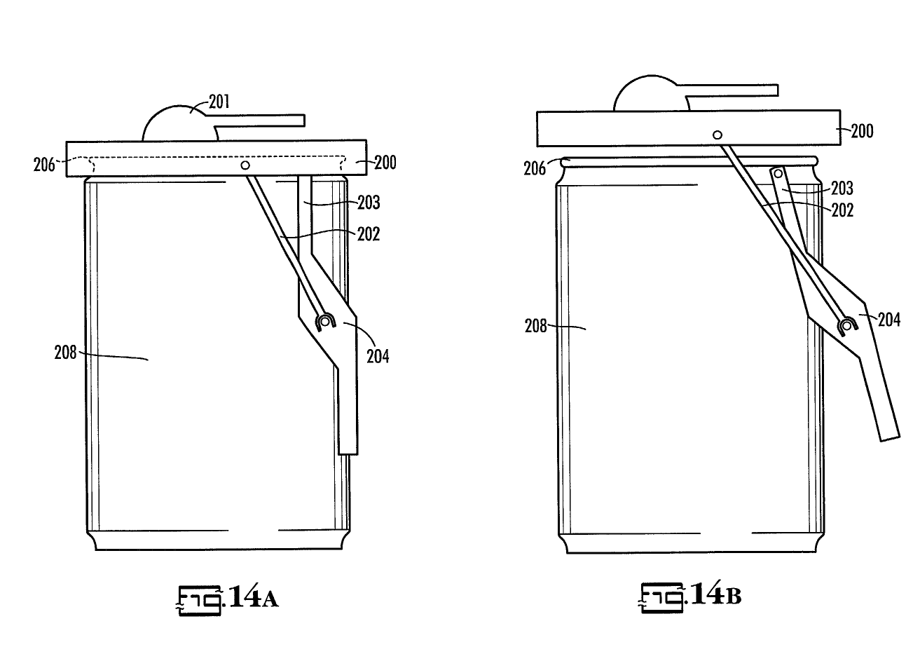

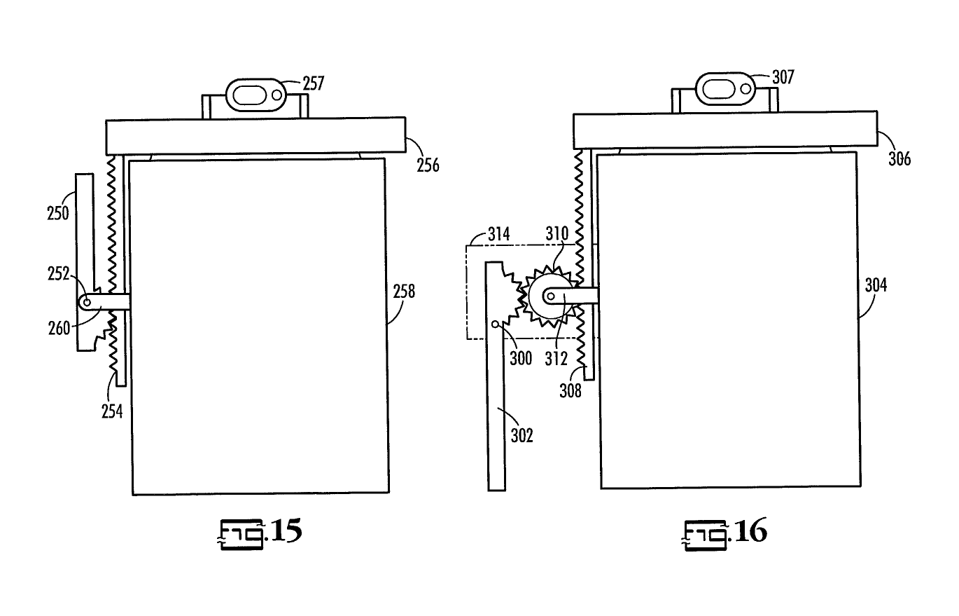

FIG. 14A is a perspective view of an embodiment employing a fork to exert pressure upwardly onto the bottom of the lip of the can. The sealing cap 200 may or may not have a spout and vent 201. Suspensory arms 202 connect the cap 200 to fork 203 and lever 204. As shown in FIG. 14B, the fork 203 pushes into the bottom of the lip 206 of can 208 to lock the cap in place. More than one set of arms 202 and fork and lever 204 may be used. Lever portion of 204 may be concave to conform to the shape of the can.

FIG. 15 shows a first embodiment of a ratchet and rack system to hold a sealing cap in place. Cap 256 which may or may not include spout 257 carries toothed rack 254 which may or may not be slide in a groove in an insulated sleeve 258. A toothed ratchet 250 hinged at offset pivot 252 supported by bracket 260 extending from container 258 draws the toothed rack 254 downwardly to hold cover 256 firmly in place on the can and/or sleeve 258.

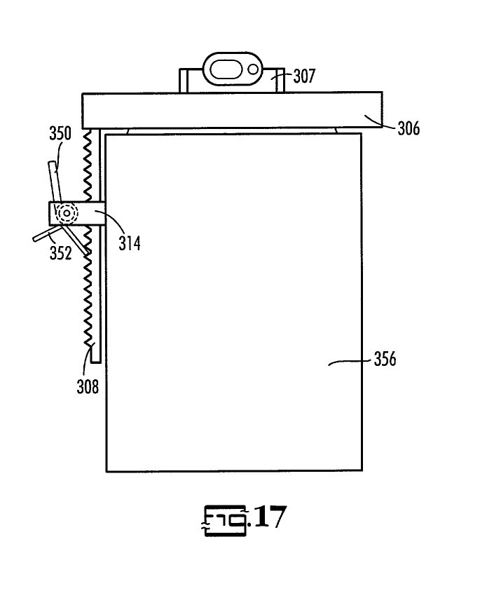

In a second embodiment of a ratchet mechanism, an intermediate gear may be interposed between the ratchet and the rack. As shown in FIG. 16, cap 306, which may or may not have a spout 307, is attached to toothed rack 308. Bracket 314 carries a hinge pin 300 to articulate handle 302. Intermediate gear 310 is interposed between the ratchet handle 302 and rack 308. The gear 310 may have its own support bracket 312 or rotate around a hinge pin supported by bracket 314. The brackets are attached to insulated container 304.

FIG. 15 and FIG. 16 show a single ratchet device but more than one may be used to provide increased pressure on the can.

A third embodiment of a toothed rack as the means for holding the sealing cap in place is shown in FIG. 17. The cap 306 with or without spout 307, bracket 314 and rack 308 are essentially as shown in FIG. 15 and FIG. 16. A locking pawl 350 urged by spring 352 is used to secure the rack and may be released by pressing on the non-engaging end. More than one pawl and rack may be used.

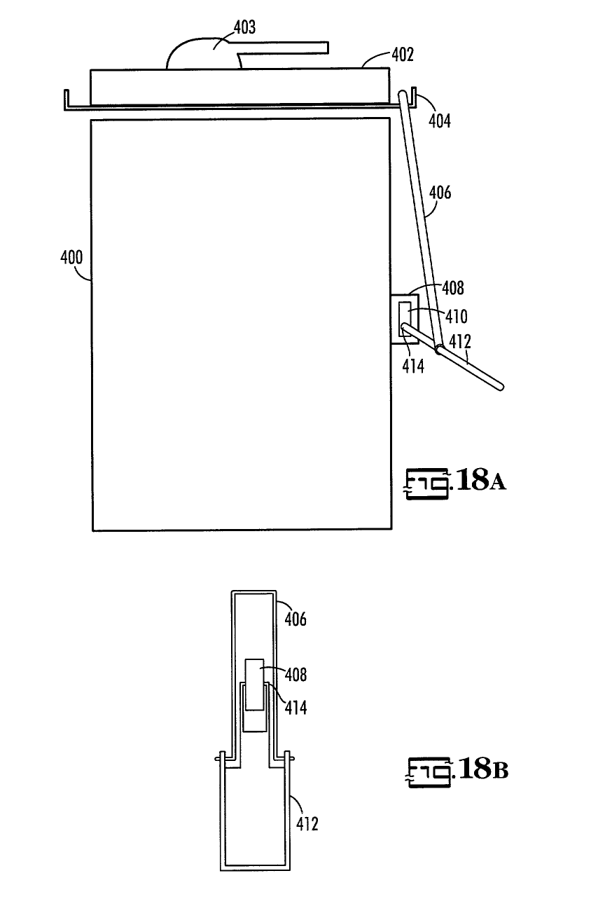

FIG. 18A and FIG. 18B show a latching mechanism. Cap 402 which may or may not have a spout 403 carries one or more protrusions or hooks 404. Loop 406 extends from lever 412 to engage element 404. Lever 412 is articulated from bracket 408 on insulated container 400 at sliding pivot 414 which travels in slot 410. Optionally, a spring may be part of bracket 408 to urge the sliding pivot 414 toward the closed position. More than one latch may be used. Alternatively, the sealing cap may be hinged to container 400 at 180° from the latch hook 404.

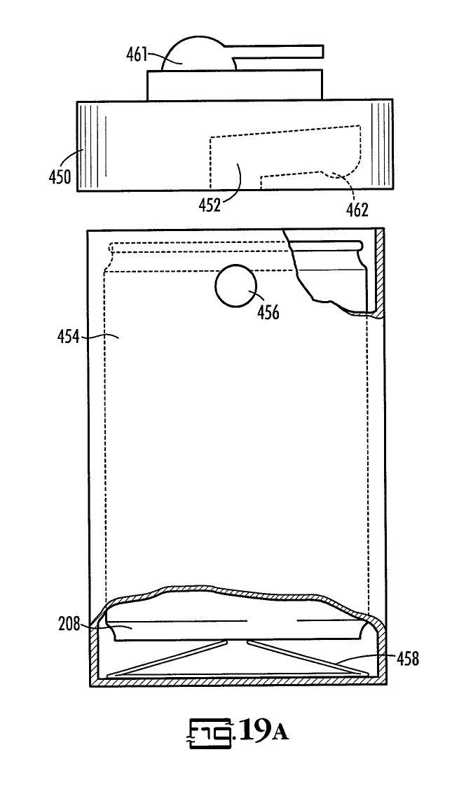

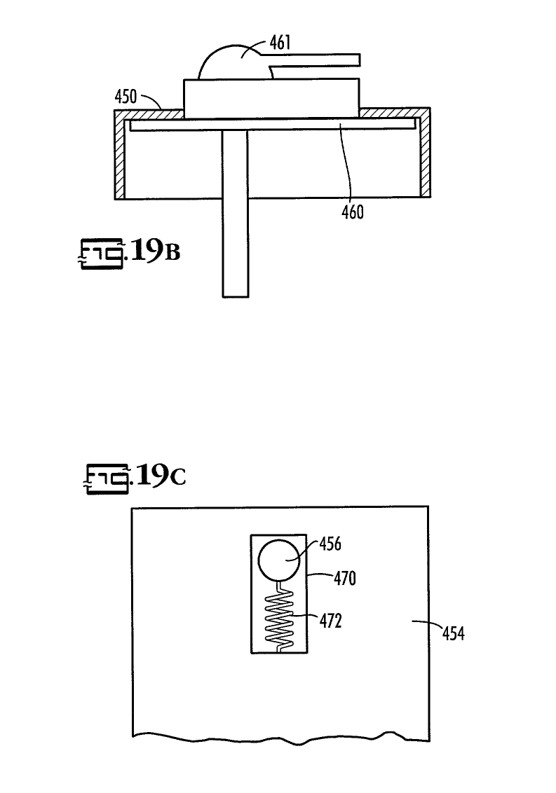

FIGS. 19A, 19B and 19C show a method of attaching the sealing cap to insulated container 454 using a spring and bayonette-type fitting. A spring 458 at the base of container 454 receives can 208. A turret and seal 460 with spout and vent 461 engages the top of can 208. A slip ring 450 with at least one internal ramp 452 and detent 462 engages a spring-loaded button 456 which floats in slot 470 which contains spring 472. When slip nut 450 is twisted, button 456 engages ramp 452 until it reaches the detent 462. Upon release of pressure, the spring 458 locks button 456 into the detent. Preferably, at least two ramps, detents and buttons are used inside the ring are used.

[TONY—DO NOT NEED A SPRING]

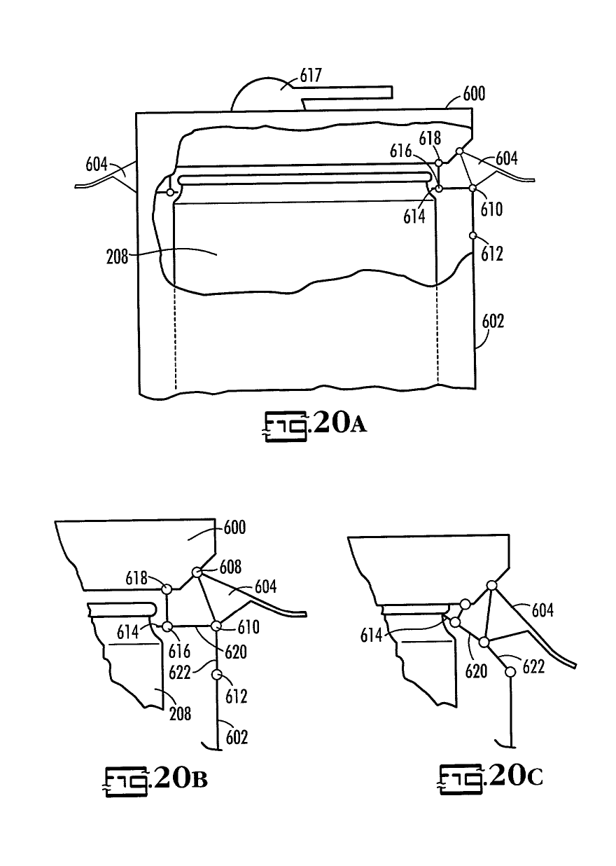

FIG. 20A shows an alternative way to hold a can 208 in an insulated container 602. In this embodiment, the can is introduced from the bottom. Lever 604 is suspended from sealing cap 600, which may or may not include spout and vent 617, in a pantograph arrangement. FIG. 20B is an expanded view of this arrangement. Lever 604 is hinged to the cap portion 600 and hinge 608. A second hinge 610 at the bottom of lever 604 connects the lever to locking clamp 614 through push rod 620 which is suspended from cap portion 608 at hinge point 618. Through hinge point 616, the lower hinge point 610 of lever 604 is also connected to the insulated container by rod 622 which is hinged at point 612. FIG. 20C illustrates the clamp in the closed position wherein the rod 622 serves to push locking clamp 614 up into the bottom of lip or can 208, more than one such clamp is preferred.

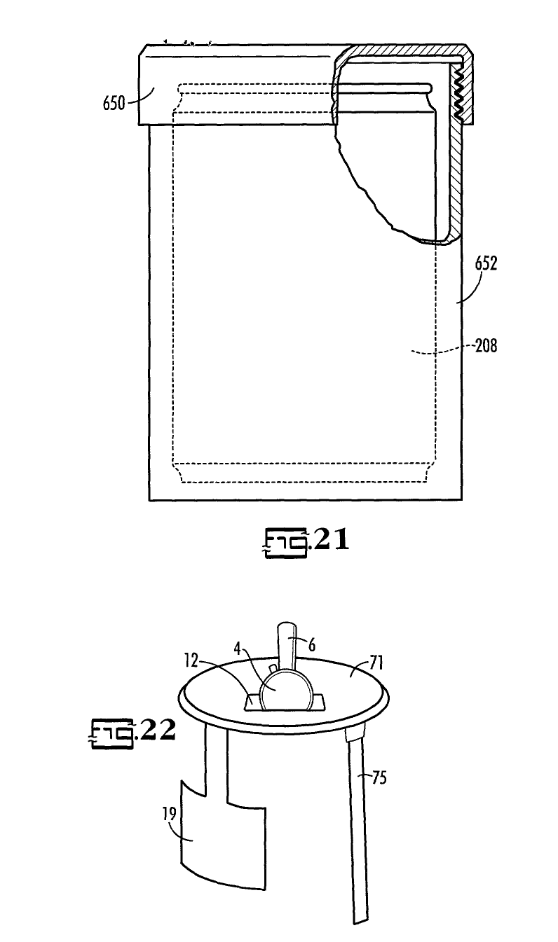

FIG. 21 illustrates an embodiment in which can 208 is placed within a double walled hard plastic container 652 and a plastic cap 650 having an inner gasket seal screwed onto the container. Preferably cap 650 is also of the double walled design. The embodiment will prevent loss of carbonation and allow the open can to be transported in any orientation.

FIG. 22 illustrates a guide which may be used for sealing caps alone or in conjunction with insulated sleeves, especially foam sleeves. A guide 19, preferably at least one-third of the length of the can, projects downwardly from the sealing cap and serves to center the can as the cap is applied. The guide is preferredly curved to conform to the curved side of the can. A second guide may also be used.

The materials used in this invention are selected on the basis of strength, formability, cost and heat conduction. Metals such as aluminum and mild steel may be used for the cap, levers and especially levers such as secondary lever 9. Metals, however, are good heat sinks and not preferred. The sealing cap is preferably made from plastic, as are the turret and projection straw 6 for cost and heat insulation. For reasons of cost, levers are preferably made from plastic. Insulating sleeve 111 is preferably a foamed plastic. Hard sleeve 121 or 130 is preferably polyethylene, HDPE or any appropriate engineering plastic material such as poly-propylene (HDPP). Injection molding is the preferred method of fabrication. Locking levers may be made from aluminum, mild steel, stainless steel 300 series or engineering plastics. The seal between cap and can should be formed from a washable rubber and is preferably attached securely to the sealing cap by water resistant adhesive or electronically. All components must be “dishwasher safe” and the turret should be dismountable for separate cleaning.

The invention has been described in terms of representative embodiments for illustrative purposes. Variations in detail which do not deviate from the concept of the invention are encompassed by the scope of the invention which is defined more particularly by the claims.

I claim:

1. A device for the sealing of an open beverage container comprising:
a sealing cap
a gasketing material disposed toward a lip of a cylindrical beverage container; and
a locking mechanism securing said sealing cap to said beverage container.

2. A device according to claim 1 wherein said locking mechanism comprises at least one clamping jaw engaging at least a portion of the circumferential surface of an upper portion of said cylindrical beverage container.

3. A device according to claim 2 wherein said at least one clamping jaw is urged into contact with said circumferential surface of an upper portion of said cylindrical beverage container by a lever.

4. A device according to claim 2 where at least one clamping jaw is urged into contact with said circumferential surface of an upper portion of said beverage container by a slip nut having a beveled ramp on a surface thereof.

5. A device according to claim 2 wherein said at least one clamping jaw is urged into contact with said circumferential surface of an upper portion of said beverage can by a plate urged against said jar by a cam.

6. A device according to claim 1 further comprising a straw projecting from a turret which acts as a valve when turned.

7. A device according to claim 6 further comprising a relief valve integrated into said turret.

8. A device according to claim 6 further comprising an insulating sleeve around at least the circumferential surface of said cylindrical beverage container.

9. A locking mechanism with at least one locking member selected from the group consisting of clamp, latch, hitch and screw whereby a seal and cover may be secured to an open container of a beverage.
